(19) United States
(12) Patent Application Publication
(10) Pub. No.: US 2005/0096937 A1
(43) Pub. Date: May 5, 2005

(54) Method of automation of business processes and apparatus therefor

(76) Inventors: Ghaisas Smita Subash, Pune (IN); Ramanathan Venkatesh, Pune (IN)

Correspondence Address: MUSERLIAN, LUCAS AND MERCANTI, LLP, 475 PARK AVENUE SOUTH, 15TH FLOOR, NEW YORK, NY, 10016, US

(21) Appl. No.: 10/978,552

(22) Filed: Nov. 1, 2004

(30) Foreign Application Priority Data
Nov. 4, 2003 (IN) 1157/MUM/2003

(51) Int. Cl. G06F 17/60

(52) U.S. Cl. 705/1

(57) ABSTRACT

A method of automation of business processes and apparatus therefor consisting of capturing requirements for carrying out of the process discretely and separately from hands on users and from managers; classifying the captured requirements into data (i) from the functional requirements viewpoint as herein defined; (ii) from the functional architectural viewpoint as herein defined; (iii) from the technical architecural viewpoint as herein defined; and (i) from the deployment architectural requirements viewpoint as herein defined; providing templates for the requirement data; providing a tool for posting requirements in a machine readable format; using the posting tool to post the classified captured requirements into the templates; providing a functional requirement analyzer for analyzing the posted data in the functional requirements view point; analyzing the requirements posted in functional requirement viewpoint template, including the step of error removal by feed back; processing the analyzed functional requirement viewpoint templates to create functional requirement artifacts; providing a prototyping means for processing the templates containing the data from functional architectural viewpoint, the technical architecural viewpoint and the deployment architectural requirements viewpoint to obtain artifacts corresponding to each of these viewpoints; verifying and validating the created artifacts to remove requirement errors; providing a framework in object oriented format to format artifacts, apply design strategies, guidelines and patterns to arrive at a solution; feeding the artifacts into the said framework; using the framework to formating the feed created artifacts for object orientation; processing the said artifacts in the framework to remove errors from the the process by back feeding, and testing the result in a virtual environment to, obtain an error free verified, validated, virtual environment tested automated machine implementable solution.

### TECHNICAL FIELD

This invention relates to an apparatus and device for application development.

In particular, this invention relates to the process of automation in application development. The automation process involves conversion of tasks and decisions done manually to a process which is at least partially accomplished through the intervention of processors.

Planning is an important aspect in accomplishing any task. Planning is more important in a business organization, for obvious commercial reasons. Planning requires the taking into account of all expected and unexpected variables which may be involved in the completing of a task or may provide possible hindrances to its timeous or efficient completion. Planning therefore requires a planner to in the first instance ascertain all the interactions and constraints [also generally called requirements] and to interrelate these requirements with one another to arrive at an optimum solution. These requirements may be inherent in the task, typically referred to as the problem domain or may be inherent in the implementation, called the solution domain.

In legacy or classic business organizations, such planning is done by human intervention. However, as tasks become more complex and are dependent upon an increasing number of variables, there is a need for automating the process for planning.

The automation process requires the development of applications which will assist a business organization in carrying out a task in hand taking into account all the practical issues confronted in carrying out a task in the overall running of an organization, typically a business organization.

### STATE OF THE ART

Different apparatus and methodologies are known for development of applications, for instance the Rational Unified Process (RUP) prescribes a Use Case-driven approach and defines views for application development. This method addresses software development lifecycle (SDLC), and is very comprehensive. It is a UML based method that promotes a use case centric approach. However RUP does not explicitly state or recommend any mechanism to identify a complete set of use cases. The granularity at which a use case should be defined is also left to the choice of a RUP user. There are no specific guidelines on how to ensure completeness and correctness of the use case model arrived at or on establishing consistency between requirements gathered from multiple stakeholders. [Philippe Kruchten, The Rational Unified Process—an Introduction, Addison-Wesley, 1999. 10(4): 13-16, 1997.]

Simialry, the KAOS approach presents a goal-oriented requirement elaboration method. The method goes by the route of identification, structuring, refinement and formalization of goals. KAOS focuses on formal refinement of high-level goals into system constraints meant as functional requirements. [Axel Van Lamsweerde, Goal-Oriented Requirement Engineering: A guided Tour, Proceedings RE'01, 5^{th} IEEE International Symposium on Requirements Engineering, Toronto, August 2001, 249-263.]

Yet another apparatus and method, the Enterprise Knowledge Development (EKD) is a refinement of Enterprise Modelling to accommodate change management. The focus here is on alternate scenarios for change and selection of the most appropriate one. These are goal-driven approaches and they focus largely on the enterprise modelling part of application development [Kerry Raymond, Reference Model of Open Distributed Processing: Introduction]

‘The Zachman framework’ organizes development processes around the points of view taken by the various players in the business environment and the things they must take into account and represents each of these as cells in a matrix. [J. A. Zachman, A Framework for information systems architecture', IBM Systems Journal, vol 26 no 3, 1987]. This framework does not have an explicit focus on requirements and does not take into account the complete software development life cycle and therefore does not offer any specific guidelines in the process of application development and planning.

Another method, ‘The Reference Model of Open Distributed Processing—RM-ODP’ also uses the notion of viewpoints for this purpose. These are goal-driven approaches and they focus largely on the enterprise modelling part of application developmennt. [Colette Rolland and Naveen Prakash, From Conceptual Modelling to Requirements Engineering, Annals of Software Engineering, 10, 151-176, 2000. This method too lacks explicit focus on requirements.

Therefore there is a need to have an approach that explicitly addresses different types of requirements and offers clear and specific guidelines to meet them through a machine implementable solution.

U.S. Pat. No. 6,571,247—Danno et al. Describes a method to generate object design information. Resources and business activities to be performed in a business to be managed in a business need to be entered hierarchically to generate the design information This covers only the analysis and design aspects of application development.

U.S. Pat. No. 6,745,381—Ehnebuske et al. describes a method and notation to enable an explicit distinction between static and dynamic features of object-oriented models. The methodology does this during the modeling process by capturing decisions to allow for business driven variability as explicit diagram annotations called control points. The business variable portions of the system of interacting objects are simultaneously captured as objects called business rules.

U.S. Pat. No. 5,996,012—Jarriel et al. describes an application builder to generate a configuration management application for use in a computing environment. Application developer creates prototyping data for a particular management application. The prototyping data is used to generate a prototype application.

For carrying out any task there are certain requirements which are perceived as necessary and essential for successfully accomplishing the task. This invention envisages a requirement centric approach to development of such applications.

Poor requirement specification is a source of many defects in application development. To address this problem, this invention provides an apparatus and method for a requirement-driven application development.

An object of this invention is to provide an apparatus and method which separates the problem domain and solution domain clearly and identifies four distinct contexts for capturing, analyzing, modeling and prototyping requirements in the course of application development.

This invention explores requirement and types of requirements as the basic distinguishing criteria for defining viewpoints and focuses on analysis of functional requirement models to detect inconsistencies.

The process in accordance with this invention separates problem domain and solution domain clearly by identifying four distinct contexts based on types of requirements for capturing, analyzing, modelling and prototyping requirements. The apparatus of this invention provides for tools for collating, compiling, model-checking, simulation and prototyping of functional requirements for consolidating requirements at an early stage of development. Once validated, the requirement models are used to synthesize an implementation using standard design patterns, strategies and guidelines. Some of the proposed techniques are implemented in a case-tool.

The separation of functional and technical concerns prescribed in accordance with this invention and supported by a tool set empowers the application developer to adapt efficiently to changing requirements and thus renders agility to application development. The process and apparatus in accordance with this invention approach makes it easy to address and find solutions to changes in different types of requirements independently and in parallel by persons with different skill-sets
Functional requirement analysts can confine changes in business requirements to problem domain models without having to deal with their platform-specific impact.
A Technical developer can focus on exploring technical architectural solutions without having to worry about the business functionality

The apparatus and method in accordance with this invention, focuses on clearly separating and classifying requirements based on their types—i.e., viewpoints and on structuring the solutions around these viewpoints. Tool-assisted transitioning of requirement models to an implemented solution on a deployment platform is an important focus area of this invention. A complete solution is synthesized from the individual solutions by applying design strategies, patterns and guidelines implemented in the tool-set designed to cooperate with the working of this invention.

The apparatus in accordance with this invention enables developers to manage change locally within each viewpoint by confining the impact of changes to relevant viewpoints. The agility in the approach in accordance with this invention comes from a tool-assisted transformation of requirement models into an implementation. Consistency checks are emphasized between the same information captured from different sets of users and tool-assisted analysis. The appartus in accordance with this invenrtion ensures quality throughout the development cycle by clearly outlining Verification & Validation in each viewpoint and by testing artifacts produced by each viewpoint independently.

This invention recognises that different persons in an organizational heirarchy have different requirements. Thus there are manager people who manage and adminster an organization through tasks and there are hands on users who execute the tasks set for them by the managers for the efficient running or an organization and carrying out defined business processes.

This invention therefore as a preliminary step in the process of automation considers it paramount that the discrete requirements of these two sets of persons the managers and the hands on users be identified and captured in machine readable format.

Every business organization has business goals. The business processes of an organization work towards satisfying thee business goals. These business processes must adhere to a set of business rules, which are typically external to the business organisation, such as for examples the Laws of the land, and the policies which are generally rules framed internally within the organization, such as for examples the rules framed for the retirement age of employees or for getting leave sanctioned.

An object of this invention is to envisage an apparatus and method of application development which focuses on requirements, clearly identifying and classifying requirements based on their types i.e., viewpoints and on structuring the solutions around these viewpoints.

The method of this invention provides that the problem domain addresses business requirements while the solution domain addresses the technical requirements. The requirement models in the problem domain capture business objectives, (rules+policies) and processes that implement the objectives as well as enterprise architecture that must support them.

These are essentially computation independent in nature. These models contain sufficient detail and precision to enable tool-assisted analysis and simulation.

In accordance with this invention, the method of this invention requires the problem domain to be structured according to The Functional Requirements Viewpoint (FRV) and the Functional Architecture Viewpoint (FAV) which comprise the problem domain.

Accordingly the solution domain has a model in the solution domain which address non-functional requirements and leverage state-of-the-art technology to define an implementation platform. These requirements are structured according to the Technical Architecture Viewpoint (TAV) and Deployment Architecture Viewpoint (DAV) which comprise the solution domain. The models of the problem domain are automatically transformed into an implementation on the deployment platform by applying design patterns, strategies and guidelines. Each viewpoint addresses requirements relevant to that viewpoint.

Thus the method and apparatus of this invention provides for separation of problem domain and solution domain through classification of requirements.

The method separates the problem domain and solution domain clearly by identifying four distinct contexts based on types of requirements for capturing, analysing, modelling and prototyping requirements. This separation of functional and technical concerns empowers the application developer to adapt to changing requirements efficiently and thus renders agility to application development. The approach in accordance with this invention makes it easy to address and find solutions to changes in different types of requirements independently and in parallel by persons with different skill-sets. For instance:
Functional requirement analysts can confine changes in business requirements to problem domain models without having to deal with their platform-specific impact.
Technical developers can focus on exploring technical architectural solutions without having to worry about the business functionality

This invention also provides for clear definition of artifacts, their content, completeness, consistency and correctness.

Artifacts of each viewpoint are clearly defined in terms of their content. The method of this invention defines a mechanism and provides a framework to ensure their correctness, completeness and consistency. Detecting inconsistencies in requirements captured thus from different users can help in consolidating the specification. Model checkers can be used to automatically detect inconsistencies.

This invention starts with typical user inputs to arrive at a use case model.

Though use case centric approach is helpful, it is a common experience that use cases are not received explicitly from users. This invention starts with capturing business processes and tasks (not use cases)—these are typical inputs from stakeholders, such as the managers and hands on users. Starting with these inputs, it provides a mechanism to arrive at a complete consistent and correct use case model. —as opposed to RUP that starts with use cases. Unlike in RUP, the method of this invention, has a clear definition of what qualifies as a use case and what is the granularity of a use case. It has clear guidelines to improve and ensure their completeness, correctness and consistency.

This invention therefore relates to development of a method of automation of business processes and apparatus therefor consisting of
[1]capturing requirements for carrying out of the process discretely and separately from hands on users and from managers;
[2] classifying the captured requirements into data (i) from the functional requirements viewpoint as herein defined; (ii) from the functional architectural viewpoint as herein defined; (iii) from the technical architecural viewpoint as herein defined; and (i) from the deployment architectural requirements viewpoint as herein defined;
[3] providing templates for the requirement data;
[4] providing a tool for posting requirements in a machine readable format
[5] using the posting tool to post the classified captured requirements into the templates;
[6] providing a functional requirement analyzer for analyzing the posted data in the functional requirements view point
[7] analyzing the requirements posted in functional requirement viewpoint template, including the step of error removal by feed back;
[8] processing the analyzed functional requirement viewpoint templates to create functional requirement artifacts;
[9] providing a prototyping means for processing the templates containing the data from functional architectural viewpoint, the technical architecural viewpoint and the deployment architectural requirements viewpoint to obtain artifacts corresponding to each of these viewpoints;
[10] verifying and validating the created artifacts to remove requirement errors;
[11]providing a framework in object oriented format to format artifacts, apply design strategies, guidelines and patterns to arrive at a solution;
[12] feeding the artifacts into the said framework;
[13] using the framework to formating the feed created artifacts for object orientation;
[14] processing the said artifacts in the framework to remove errors from the the process by back feeding, and testing the result in a virtual environment to obtain an error free verified, validated, virtual environment tested automated machine implementable solution.

The invention also provides an apparatus for automation of business processes comprising
[i] four sets of discrete templates:
[a] one set of templates for posting requirements from a functional requirements viewpoint as herein defined;
(b) one set of templates for posting requirements from a functional architectural viewpoint as herein defined;
(c) one set of templates for posting requirements from a technical architecural viewpoint as herein defined; said set including and
(d) one set of templates for posting requirements from a deployment architectural requirements viewpoint as herein defined;
[ii] a posting tool for posting captured and classified requirememnts into the said templates;
[iii] a checking, analyzing and processing tool for checking and analysing the templates posted with the said functional requirements viewpoint and processing the checked analyzed and verified templates to obtain a firdt set of artifacts;
[iv] prototyping means for receiving the templates in the FAV<TAV and DAV to create to create a second set of artifacts;
[v] a framework to receive and process the artifacts to provide an autmoated business solution.

The 4 sets of discrete templates may in accordance with a preferred embodiment of this invention include:
[i] one set of templates for posting requirements from a functional requirements viewpoint as herein defined; said set including a template derived from hands on user for posting requirements from a database containing tasks and validation; a template derived from managers for posting requirements from a database containing goals of the organisation; a template derived from managers for posting requirements from a database containing business rules; a template derived from managers for posting requirements from a database containing policies of the organisation; a template derived from managers for posting requirements from a database containing business processes essential and necessary for the operation opf the business;
(ii) one set of templates for posting requirements from a functional architectural viewpoint as herein defined; said set including a template derived from hands on user for posting requirements from a database containing component functionality; a template derived from hands on user for posting requirements from a database containing interdependencies; a template derived from managers for posting requirements from a database containing functional scope boundaries; a template derived from managers for posting requirements from a database containing componenent identification; a template derived from managers for posting requirements from a database containing organisational structure;
(iii) one set of templates for posting requirements from a technical architecural viewpoint as herein defined; said set including a template derived from hands on user for posting requirements from a database containing performance requiremments; a template derived from hands on user for posting requirements from a database containing graphic user interfaces; a template derived from hands on user for posting requirements from a database containing work load; a template derived from hands on user for posting requirements from a database containing data migration; a template derived from managers for posting requirements from a database containing performance requirements; a template derived from managers for posting requirements from a database containing graphic user interface; a template derived from managers for posting requirements from a database containing work load; a template derived from managers for posting requirements from a database containing security a template derived from managers for posting requirements from a database containing data migration; and
(iv) one set of templates for posting requirements from a deployment architectural requirements viewpoint as herein defined; said set including a template derived from hands on user for posting requirements from a database containing release plans; a template derived from hands on user for posting requirements from a database containing roll out plans; a template derived from hands on user for posting requirements from a database containing, configuration management strategies; a template derived from hands on user for posting requirements from a database containing installation process building tools; a template derived from hands on user for posting requirements from a database containing data archival and back up; a template derived from managers for posting requirements from a database containing availabilities; a template derived from managers for posting requirements from a database containing remote access; a template derived from managers for posting requirements from a database containing support structures; a template derived from managers for posting requirements from a database containing data archival and back up.

The invention will now be described with reference to the accompanying drawings, in which

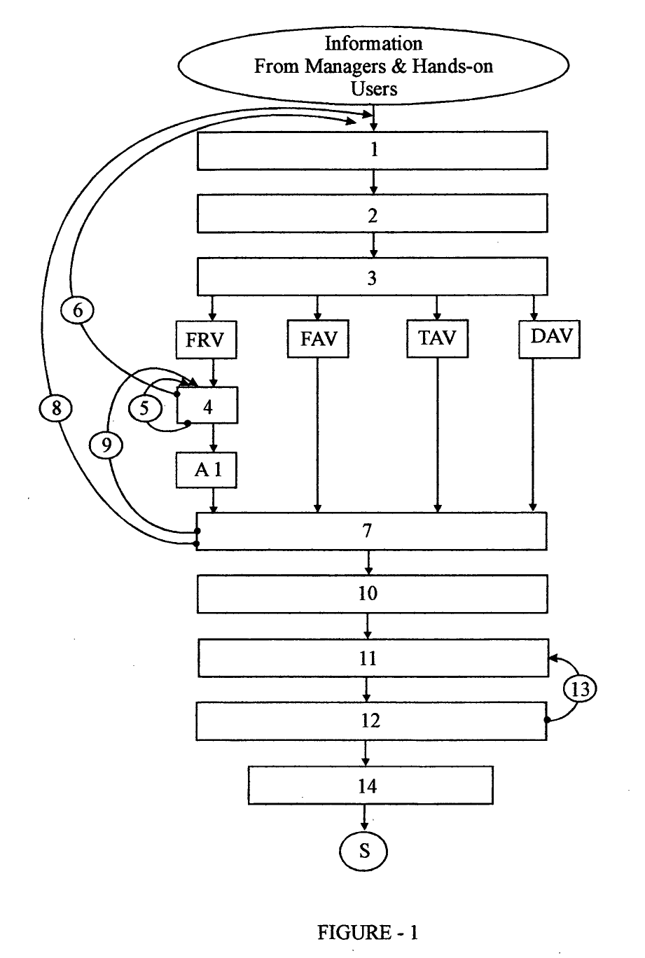

FIG. 1 is a block schematic drawing of the process of this invention;

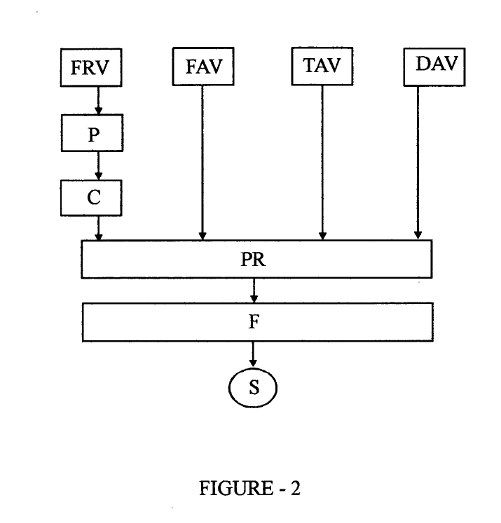

FIG. 2 is a block schematic drawing of the apparatus for use in the method of this invention;

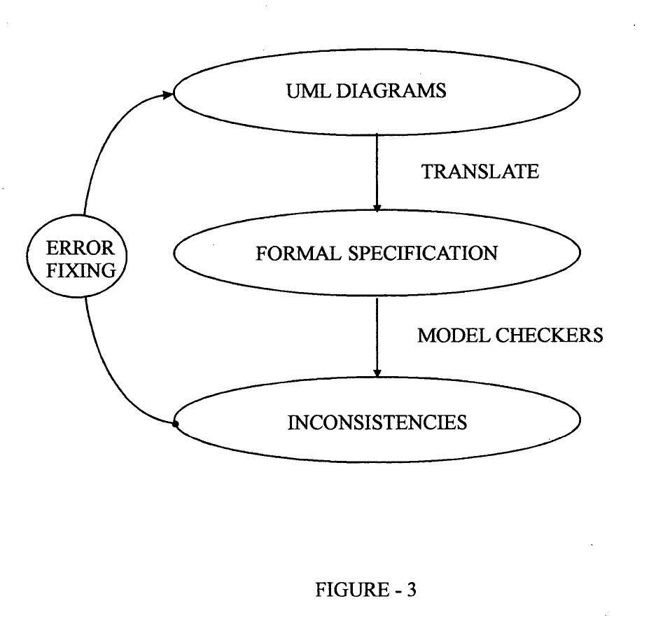

FIG. 3 illustrates a mechanism through which analysis is carried out within the process of FIG. 1.

Referring to the drawings a method of automation of business processes of this invention is illustrated in FIG. 1 of the drawings. The method includes the following steps
a step of capturing [1] requirements for carrying out of the process discretely and separately from hands on users and from managers is followed by a step of classifying [2] the captured requirements into data (i) from the functional requirements viewpoint; (ii) from the functional architectural viewpoint; (iii) from the technical architecural viewpoint; and (i) from the deployment architectural requirements viewpoint.

Discrete templates are provided for the requirement data and a tool is provided for posting requirements in a machine readable format

The posting tool is used to post [3] the classified captured requirements into the templates Functional Requirements Viewpoint (FRV), Functional Architecture Viewpoint (FAV) Technical Architecture Viewpoint (TAV) and Deployment Architecture Viewpoint (DAV). A functional requirement analyzer is provided for analyzing the posted data in the functional requirements view point. The process step [4] includes analyzing the requirements posted in functional requirement viewpoint template and includes a step [5] of analyses and error removal by feed back to the posting of the template and back to the requirememnt capturing step [6].

The analyzed functional requirement viewpoint templates are processed [4] to create functional requirement artifacts A1.

A prototyping means is provide for processing the templates containing the data from functional architectural viewpoint, the technical architecural viewpoint and the deployment architectural requirements viewpoint to obtain artifacts corresponding to each of these viewpoints.

The process step [7] includes the step of verifying and validating the created artifacts including artifacts A1 and a step [8] to analyse and remove requirement errors by feedback mechanisms to the capturing step [1] and a step [9] to the analyzer step [4].

A framework in object oriented format is provided to format artifacts, apply design strategies, guidelines and patterns to arrive at a solution. The artifacts created are feed [10] into the said framework and the framework is used to formating [11] the created artifacts for object orientation. The framework is further used to process [12] the said artifacts in the framework to remove errors from the the process by back feeding [13], and testing the result in a virtual environment [14] to obtain an error free verified, validated, virtual environment tested automated machine implementable solution (S).

For developing the process in accordance with this invention, the viewpoint model looks at the process from the viewpoint of the requirements the problem domain addresses business requirements while the solution domain addresses the technical requirements. The requirement models in problem domain capture business objectives, (rules+policies) and processes that implement the objectives as well as enterprise architecture that must support them. These are essentially computation independent in nature. These models contain sufficient detail and precision to enable tool-assisted analysis and simulation. The Functional Requirements Viewpoint (FRV) and the Functional Architecture Viewpoint (FAV) comprise the requirememnts in the problem domain. The models in the solution domain address non-functional requirements and leverage state-of-the-art technology to define an implementation platform. The Technical Architecture Viewpoint (TAV) and Deployment Architecture Viewpoint (DAV) comprise the requirements in the solution domain. The models of the problem domain are automatically transformed into an implementation on the deployment platform by applying design patterns, strategies and guidelines. This appartus embedd in processing means makes it possible to confine changes in business requirements to problem domain models without having to deal with their platform-specific impact. It also lets a technical developer focus on exploring technical architectural solutions without having to worry about the business functionality. This separation of functional and technical concerns empowers the application developer to adapt to changing requirements efficiently and thus renders agility to application development.

Each viewpoint addresses requirements relevant to that viewpoint. Development proceeds along each viewpoint using the standard—requirements capture analysis, specification/coding and testing—cycle. The key point to note is that the artifacts produced by each viewpoint are tested independently of other viewpoints.

FIG. 2 of the accompanying drawings illustrate the apparatus block diagram for carrying out the method of automation of business process as described in FIG. 1.

The apparatus includes
[i] four sets of discrete templates:
[a] one set of templates for posting requirements from a functional requirements viewpoint [FRV] as herein defined;
(b) one set of templates for posting requirements from a functional architectural viewpoint [FAV] as herein defined;
(c) one set of templates for posting requirements from a technical architecural viewpoint [TAV] as herein defined; said set including and
(d) one set of templates for posting requirements from a deployment architectural requirements viewpoint [DAV] as herein defined;
[ii] a posting tool [P] for posting captured and classified requirememnts into the said templates;
[iii] a checking , analyzing and processing tool [C] for checking and analysing the templates posted with the said functional requirements viewpoint and processing the checked analyzed and verified templates to obtain a first set of artifacts;
[iv] prototyping means [PR] for receiving the templates containing the FAV, TAV and DAV to create a second set of artifacts;
[v] a framework [F] to receive and process the artifacts to provide an automated business solution [S].

The requirements after capturing and classification are posted into the templates in accordance with this invention.

The apparatus for carrying out the method in accordance with this invention includes Tools for posting the requirements
Tools such as MasterCraft or Rational Rose that support diagrams in Unified Modeling language (UML). [G. Booch, J. Rumbaugh and I. Jacobson; The Unified Modeling Language User Guide, Addison-Wesley, 1998] can be used.

In the process of posting
Business processes are grouped using a suitable criterion such as departments in an organization, process owners. These are represented using the package diagrams in UML.
Business processes are elucidated by identifying process steps and actors involved. These are represented using Activity diagrams in UML.
Tasks performed by hands-on users are represented in use case diagrams in UML. Additionally, use templates are used to document detailed use cases including pre and post conditions, validations.
The static structure of an application is represented using business entity model. The business entity model also includes cardinality constraints. This can be shown using class diagram notation of UML.
Rules can be shown as constraints in a class diagram

The templates are in text format and simplify the task of requirements capture, classification and organization and structuring. They help a requirement analyst to pose the right kind of questions to the user. This invention provides the following templates for capturing inputs from manager and hands in users.

Functional Requirements Viewpoint (FRV) template sets include

Templates for
1. Organizational context
2. Business goals
3. Stakeholders and their expectations
4. Business rules and policies
5. Grouping of business process
6. Special scenarios
7. Review for goal alignment
8. Tasks and validations
9. Review for consistency
10. Goal tracking through reports
11. Glossary of business terms and business entity models
12. Rapid prototyping
13. verification and Validation
14. Feedback

This set of templates addresses application functionality requirements from the business user's point of view. This set of templates includes a template derived from hands on user for posting requirements from a database containing tasks and validation; a template derived from managers for posting requirements from a database containing goals of the organisation; a template derived from managers for posting requirements from a database containing business rules; a template derived from managers for posting requirements from a database containing policies of the organisation; a template derived from managers for posting requirements from a database containing business processes essential and necessary for the operation opf the business. The business users can be of two types: managers/business process owners who can give inputs on business rules, policies and processes and hands-on users who can give inputs on tasks to be performed using the application, in order to implement the processes. The business processes captured from managers/process owners are elucidated by identifying process steps. These may be manual or automated. Use Cases captured from hands-on users should be consistent with automatable process steps. Also the business rules captured from managers/process owners should be consistent with validations specified by hands-on users. Detecting inconsistencies in requirements captured thus from different users can help in consolidating the specification. The analyzing of the templates is done by model checkers to automatically detect inconsistencies. Important FRV artifacts include a glossary of business terms, objectives, rules, processes, policies, use cases and validations corresponding to use cases. The artifacts also include business entity models. The prototypes are functional prototypes that would give the users a feel for the realization of desired application functionality.

Functional Architecture Viewpoint (FAV) templates set include

Templates for
1. Functional scope boundary identification
2. Organizational structure
3. Component development decisions
4. Component responsibilities
5. Component definitions
6. Component interdependencies
7. Review for goal alignment
8. verification and validation

These templates address requirements pertinent to the enterprise architecture. This set of templates includes a template derived from hands on user for posting requirements from a database containing component functionality; a template derived from hands on user for posting requirements from a database containing interdependencies; a template derived from managers for posting requirements from a database containing functional scope boundaries; a template derived from managers for posting requirements from a database containing componenent identification; a template derived from managers for posting requirements from a database containing organisational structure.

Identifying and defining components to be developed, making decisions about the reuse of existing components, purchase of commercial components and determining the inter-component interaction are important activities in this viewpoint. Assigning the requirements (captured in FRV) to appropriate development components helps in logical partitioning of the application to be developed. In FAV, the artifacts include identification of reusable components, assignment of requirements to components and inter-component relationships. The end users will evaluate the functional architecture in terms of the functionality offered by each of the components, their logical coherence, modularity, and their potential for reuse.

Technical Architecture Viewpoint (TAV) templates set address non-functional requirements necessary to implement the business requirements defined in the problem domain viewpoints (FRV and FAV). This set of templates include Templates for
1. Performance requirements
   a. Transaction related targets
   b. Workload estimation
2. GUI design
3. Security requirements
4. Data migration
5. Architecture selection
6. Technical architecture solution
7. Platform choices
8. Design decisions
9. Mapping of business components to technical architecture
10. Component interfaces
11. Class design
12. prototyping
13. Testing
14. Verification and Validation
15. feedback

This set of templates include a template derived from hands on user for posting requirements from a database containing performance requirements; a template derived from hands on user for posting requirements from a database containing graphic user interfaces; a template derived from hands on user for posting requirements from a database containing work load; a template derived from hands on user for posting requirements from a database containing data migration; a template derived from managers for posting requirements from a database containing performance requirements; a template derived from managers for posting requirements from a database containing graphic user interface; a template derived from managers for posting requirements from a database containing work load; a template derived from managers for posting requirements from a database containing security a template derived from managers for posting requirements from a database containing data migration. Precise quantification of technical requirements, identification of technical components, The apparatus in accordance with this invention ping of the enterprise architecture components (identified in FAV) onto the technical architecture, implementing the solution and testing it are important activities in this viewpoint. TAV artifacts include multiple prototypes to validate the technical architecture and platform choices compliant with functional requirements.

Deployment Architecture Viewpoint (DAV) trmplate set addresses the requirements relevant to the post-delivery phase to ensure a smooth running of a deployed application. The set includes templates for
1. Physical architecture
2. Roll out plan
3. Configuration management
4. Installation
5. Initial set up
6. Data archival and- back-up starategy
7. Support structure
8. Documentation
9. Training
10. Parallel run
11. High availability
12. Checklist

The set has a template derived from hands on user for posting requirements from a database containing release plans; a template derived from hands on user for posting requirements from a database containing roll out plans; a template derived from hands on user for posting requirements from a database containing configuration management strategies; a template derived from hands on user for posting requirements from a database containing installation process building tools; a template derived from hands on user for posting requirements from a database containing data archival and back up; a template derived from managers for posting requirements from a database containing availabilities; a template derived from managers for posting requirements from a database containing remote access; a template derived from managers for posting requirements from a database containing support structures; a template derived from managers for posting requirements from a database containing data archival and back up.

Identifying physical architecture, making a roll-out and release plan, installation builds and scripts, training program, user documentation, helpdesk and support mechanism are important activities in this viewpoint.

The verification and validation (V&V) in this viewpoint include obtaining user acceptance and feedback for enhancements and bug fixes.

The tool-set cooperating with the appartus of this invention is parameterized by design patterns and well-tested strategies and guidelines. Using tool-assisted support for formal specification, analysis and rapid prototyping of requirements, a developer can change requirements when necessary, specify them formally, analyze them and detect inconsistencies in them. Once consolidated, their implementation can be done through automated transformation mechanisms.

Once all the requirements are posted in the templates the templates are analyzed. The mechanism through which analysis is carried out is represented in the block shown in FIG. 3 of the accompanying drawings The requirements posted using UML diagrams are typically translated into formal specifications. The resulting specifications are processed using model checkers. For example, specification language TLA and its associated model checker TLC can be used to verify object models with assertions specifying pre- and post-conditions for operations and invariants. [L. Lamport, Specifying Systems: The TLA+Language Tools for Hardware and Software Engineers, Addison-Wesley, 2002].

The errors detected by the model checker are caught either as instances of invariant violation or absence of necessary invariants in original specifications. By inspecting the error trace generated, it is possible to locate the source of the error. Several inconsistencies indicating rule violations can be detected out of the original informal specifications.

Using tool-assisted support for formal specification, analysis and rapid prototyping of requirements, a developer can change requirements when necessary, specify them formally, analyze them and detect inconsistencies in them.

Prototypes generated using tools such as MasterCraft form first cut artifacts. Final set of artifacts produced in each viewpoint are verified and validated.

Multiple prototypes and verification and validation (V&V) mechanisms in each viewpoint are outlined to incorporate user feedback iteratively. In each viewpoint artifacts are clearly defined, rapid prototyping is done followd by Verification &Validation to be done by users

Project planning can be done around baselines in each viewpoint, defined as follows. The FRV baseline comprises requirements that correspond to some of the core business processes and critical scenarios. Correspondingly, the FAV baseline includes business components necessary for incorporation of the business processes identified in the FRV baseline. The TAV baseline comprises technical architecture components necessary for implementation of the FRV and FAV baselines. The DAV baseline includes partial physical architecture necessary for deployment of the baselined solution

A main feature in accordance with this invention is the clear definition of artifacts, their content, completeness, consistency and correctness.

Artifacts of each viewpoint are clearly defined in terms of their content. The process in accordance with this invention defines a mechanism and provides a framework to ensure their correctness, completeness and consistency. Detecting inconsistencies in requirements captured thus from different users can help in consolidating the specification. Model checkers can be used to automatically detect inconsistencies.

Another feature of this invention is starting with typical user inputs to arrive at a use case model.

Though use case centric approach is helpful, it is a common experience that use cases are not clearly received explicitly from users. The process in accordance with this invention starts with capturing business processes and tasks (not use cases)—these are typical inputs from stakeholders. Starting with these inputs, it provides a mechanism to arrive at a complete consistent and correct use case model. —as opposed to RUP that starts with use cases. Unlike in RUP, the process in accordance with this invention has a clear definition of what qualifies as a use case and what is the granularity of a use case. It has clear guidelines to improve and ensure their completeness, correctness and consistency.

The artifacts are fed into a framework. Such a framework is provided with interpreters and translators for object oriented models and code generators. To impart productivity and good quality to the generated solution the frameworks is provided with well tested design patterns, strategies and guidelines adapted to transform the selected artifacts into an implemented i.e. machine readable solution. Examples of such a frame work include, Mastercraft, Rational Rose, Coolgen. These frameworks take object oriented models[artifacts] as inputs and generate platform specific solutions. These frameworks have model aware internal tools such as translators, code generators, data definition language generators, graphical user interface generators and the like that aid in the transformation.

In summary, the apparatus in accordance with this invention,
follows a requirement centric approach that separates problem domain and solution domain specific contexts
Allows parallel application development by addressing different kinds of requirements through separate viewpoints
Clearly identifies actors, activities, artifacts and Verification & Validation (V&V) in each viewpoint
Promotes agile development by prescribing iterative development to incorporate user feedback through prototyping, too usage, and
Verification &Validation to effectively manage continuous change
Is a Generic process that can be customized to many different project needs
   Advantage

The apparatus in accordance with this invention
separates problem domain and solution domain clearly
Identifies four distinct contexts for capturing, analyzing, modeling and prototyping requirements
ensures consistency checks between requirements captured from managers/business process owners and hands-on users

Types of requirements have been used as the basic distinguishing criteria for defining viewpoints

Tool-assisted transitioning of requirement models to an implemented solution on a deployment platform
enables developers to manage change locally within each viewpoint
Renders agility

focuses on quality throughout the development cycle
by clearly outlining V&V in each viewpoint
testing artifacts produced by each viewpoint independently.

The invention will now be described with reference to Case study using the method and apparatus of this invention for implementation

A simple “library management” example is presented here to illustrate the approach in accordance with this invention to application development. The details presented here are representative and not comprehensive.

A library maintains a collection of books. Members of a library borrow and return books. On return of a book, if there are pending claims for the title, the book is held for one of the claimants.

Functional Requirement Viewpoint, Functional Architectural Viewpoint, Technical Architectural Viewpoint, and Deployment Architectural Viewpoint Templates were previously created and provided.

The stakeholders werre divided into two broad categories-managerial users and hands-on users. Inputs from representatives of both the sets of users are captured. The managerial users typically help specify invariants of the application while the hands-on users will help specify possible interactions with the application to be developed. The librarian was a representative managerial user and library clerk and borrowers—the hands-on users.

Inputs from librarian [manager]
Book borrowing process
Book reservation process
Rules that apply to borrowing, reservation
Process of budget for a library—hierarchies involved in approval
Existing system with which the proposed system may have to interact when a title has to be requested from the main library in a remote location.
GUI preferences—logos to be displayed on screens
Remote access requirements

Inputs from borrower [hands on user]
Query on availability of a book-title
Put a claim on a book-title
Response time while searching for a title

Inputs from clerk [hands on user]
Issue overdue reminder to borrowers
Issue fine to defaulters

The requirements inputs from users were categorized into four types of requirements as defined by the four viewpoints of the process in accordance with this invention. Examples are given below

FRV

From librarian
Book borrowing process
Book reservation process
Rules that apply to borrowing, reservation

From Borrower
Query availability on a title before issue/reserve
View borrower details of a book if not available

From Clerk
View defaulter details
Calculate fine
Send notice.

FAV

From librarian
Organizational hierarchy:
   Process of budget for a library—hierarchies involved in approval
Existing system with which the proposed system may have to interact when a title has to be requested from the main library in a remote location.

TAV

From librarian
GUI preferences—logos to be displayed on screens
   From Borrower
Response time preference
   From librarian and borrower

DAV
Remote access
Availability

The requirements were captured in detail using the templates as guidelines and were classifed accordingly.

A posting tool was used to post the requirements in the templates in the form of business entity diagrams and process diagrams. UML class models were used to capture rules, business entity models and activity diagrams to capture business processes. The UML notation is extended using stereotypes.

Table 1 captures a simplistic partial enterprise model for such a system. The ‘Borrow’ and the ‘Return’ processes should be checked for their conformance to Rule 1 and Rule 2.

TABLE 1
Partial Model for the Library System

| | | |
|---|---|---|
| Business | Everything that is a part of | Book, Member, Title, Loan, |
| entities | the | Claim |
| | enterprise-persons, things, | |
| | concepts | |
| Rules | Policies, Objectives, Laws | Rule1: ‘A book shall be |
| | of | issued to only one person’ |
| | land, Domain | Rule2: ‘An available book |
| | | shall be held for claimant, if |
| | | any’ |
| Processes | Steps to achieve objectives | Borrow |
| | Should not violate the rule | Available? -Issue |
| | | else-put claim and issue |
| | | when available |
| | | Return |
| | | No claims? Make available |
| | | else-hold for claimant |

Invariant on the entity Book: A book in a library will be either loaned to a member, or held for a claimant or available (if there are no claims)

Borrow: (1). A library member can borrow a book if it is available; i.e., it is not loaned or held for another member. (2) If it is not available, a claim can be put against a title. (3) When available and loaned to the claimant, the claim should automatically get cancelled. (4) A claim cannot be put against a title that is already available and is not held for any claimant.

Return: (1) A library member may return a book issued to her. (2) On return, the book becomes available to other members, if there are no claims against the title. (3) If there is a claim against it, the book should be held for the claimant.

Analysis and Processing

After translating the visual specifications into a formal notation, the resulting specification was processed using a model checker. The specification language TLA [L. Lamport, Specifying Systems: The TLA+ Language Tools for Hardware and Software Engineers, Addison-Wesley, 2002] and its associated model checker TLC were used to verify object models with assertions specifying pre- and post-conditions for operations and invariants.

Several errors were detected in the original specification of the library system. By inspecting the error trace generated, we were able to locate the source of the error. Several inconsistencies indicating rule violations could be detected out of the original informal specifications. The errors detected by the model checker were caught either as instances of invariant violation or absence of necessary invariants in our original specifications.

Some of the invariants that were not specified earlier and detected using the automated analysis were:
A borrower can put a claim for at the most three titles
A borrower cannot put a claim on the title (s)he is currently holding

Artifacts

FRV

The FRV artifacts included a functional prototype of “Borrow Book” process.

FAV

In FAV, the artifacts include identification components to be developed, purchased and outsourced, assignment of requirements to components and inter-component relationships. With the Library System discussed here, we can identify Library Management as one of the functional architecture components. The services like ‘Borrow’, ‘Return’, ‘Cancel’, and ‘Reserve’ should be assigned to this component. The Library System may have to interact with an existing Accounts Management component for processes relevant to budgeting and purchase of new books. Also when a title is to be requested from the main library, it should interface with the existing system at the main library.

TAV

The TAV addresses precisely quantified technical requirements such as performance and usability. The Library System under discussion posde the following kind of requirements in the context of this viewpoint (1) It should be possible for 5000 members to log on concurrently. (3) Response time should be not more than 4 sec. TAV artifacts include multiple prototypes to validate the technical architecture and platform choices compliant with functional requirements. Prototypes that validate these requirements were built.

DAV

The DAV caters largely to post-delivery requirements like ensuring availability of an application, roll-out and release plans and achieving user comfort. For example, addressing a requirement of 24/7 availability and remote access prompts a developer to examine the necessity to replicate servers and databases at multiple locations, having an archival strategy with minimum down time.

Verification and Validation

The prototypes were validated. Feedback was taken into account and corrective measures were taken to implement user suggestions For example, The special scenario wherein a borrower associated with research and development unit can borrow 5 books at a time instead of 2 was also incorporated.

Generation Framework

Transition from requirements to an implementation was automated through the use of MasterCraft. [ It is a proprietary case tool of Tata Consultancy Services Ltd] The tool incorporatse well-tested design patterns, guidelines and strategies. The validated requirement models were used as inputs to MasterCraft. The tool uses OO models as inputs to generate a platform specific solution. The generated solution was tested using the testing support in tools such as MasterCraft. Errors at the testing stage are corrected iteratively and a final deployable solution is generated.

Deploying Solution

The generated solution was deployed onto the actual physical architecture. User acceptance testing was carried out.

While considerable emphasis has been placed herein on the structures and structural interrelationships between the component parts of the preferred embodiments, it will be appreciated that many embodiments can be made and that many changes can be made in the preferred embodiments without departing from the principals of the invention. These and other changes in the preferred embodiment as well as other embodiments of the invention will be apparent to those skilled in the art from the disclosure herein, whereby it is to be distinctly understood that the foregoing descriptive matter is to be interpreted merely as illustrative of the invention and not as a limitation.

1. A method of automation of business processes and apparatus therefor consisting of
[1]capturing requirements for carrying out of the process discretely and separately from hands on users and from managers;
[2] classifying the captured requirements into data (i) from the functional requirements viewpoint as herein defined; (ii) from the functional architectural viewpoint as herein defined; (iii) from the technical architecural viewpoint as herein defined; and (i) from the deployment architectural requirements viewpoint as herein defined;
[3] providing templates for the requirement data;
[4] providing a tool for posting requirements in a machine readable format
[5] using the posting tool to post the classified captured requirements into the templates;
[6] providing a functional requirement analyzer for analyzing the posted data in the functional requirements view point
[7] analyzing the requirements posted in functional requirement viewpoint template, including the step of error removal by feed back;
[8] processing the analyzed functional requirement viewpoint templates to create functional requirement artifacts;
[9] providing a prototyping means for processing the templates containing the data from functional architectural viewpoint, the technical architecural viewpoint and the deployment architectural requirements viewpoint to obtain artifacts corresponding to each of these viewpoints;
[10] verifying and validating the created artifacts to remove requirement errors;
[11] providing a framework in object oriented format to format artifacts, apply design strategies, guidelines and patterns to arrive at a solution;
[12] feeding the artifacts into the said framework;
[13] using the framework to formating the feed created artifacts for object orientation;
[14] processing the said artifacts in the framework to remove errors from the the process by back feeding, and testing the result in a virtual environment to obtain an error free verified, validated, virtual environment tested automated machine implementable solution.

2. An apparatus for automation of business processes comprising
[i] four sets of discrete templates:
[a] one set of templates for posting requirements from a functional requirements viewpoint as herein defined;
(b) one set of templates for posting requirements from a functional architectural viewpoint as herein defined;
(c) one set of templates for posting requirements from a technical architecural viewpoint as herein defined; said set including and
(d) one set of templates for posting requirements from a deployment architectural requirements viewpoint as herein defined;
[ii] a posting tool for posting captured and classified requirememnts into the said templates;
[iii] a checking, analyzing and processing tool for checking and analysing the templates posted with the said functional requirements viewpoint and processing the checked analyzed and verified templates to obtain a firdt set of artifacts;
[iv] prototyping means for receiving the templates in the FAV<TAV and DAV to create to create a second set of artifacts;
[v] a framework to receive and process the artifacts to provide an autmoated business solution.

3. An apparatus for automation of business processes as claimed in claim 2, in which said set of templates for posting requirements from a functional requirement viewpoint includes said set including a template derived from hands on user for posting requirements from a database containing tasks and validation; a template derived from managers for posting requirements from a database containing goals of the organisation; a template derived from managers for posting requirements from a database containing business rules; a template derived from managers for posting requirements from a database containing policies of the organisation; a template derived from managers for posting requirements from a database containing business processes essential and necessary for the operation of the business.

4. An apparatus for automation of business processes as claimed in claim 2, in which said set of templates for posting requirements from a functional architectural viewpoint includes a template derived from hands on user for posting requirements from a database containing tasks and validation; a template derived from managers for posting requirements from a database containing goals of the organisation; a template derived from managers for posting requirements from a database containing business rules; a template derived from managers for posting requirements from a database containing policies of the organisation; a template derived from managers for posting requirements from a database containing business processes essential and necessary for the operation of the business.

5. An apparatus for automation of business processes as claimed in claim 2, in which said set of templates for posting requirements from a technical architectural viewpoint includes a template derived from hands on user for posting requirements from a database containing performance requirements; a template derived from hands on user for posting requirements from a database containing graphic user interfaces; a template derived from hands on user for posting requirements from a database containing work load; a template derived from hands on user for posting requirements from a database containing data migration; a template derived from managers for posting requirements from a database containing performance requirements; a template derived from managers for posting requirements from a database containing graphic user interface; a template derived from managers for posting requirements from a database containing work load; a template derived from managers for posting requirements from a database containing security a template derived from managers for posting requirements from a database containing data migration.

6. An apparatus for automation of business processes as claimed in claim 2, in which said set of templates for posting requirements from a deployment architectural requirements viewpoint includes a template derived from hands on user for posting requirements from a database containing release plans; a template derived from hands on user for posting requirements from a database containing roll out plans; a template derived from hands on user for posting requirements from a database containing configuration management strategies; a template derived from hands on user for posting requirements from a database containing installation process building tools; a template derived from hands on user for posting requirements from a database containing data archival and back up; a template derived from managers for posting requirements from a database containing availabilities; a template derived from managers for posting requirements from a database containing remote access; a template derived from managers for posting requirements from a database containing support structures; a template derived from managers for posting requirements from a database containing data archival and back up.
